(19) United States
(12) Patent Application Publication
(10) Pub. No.: US 2011/0117788 A1
(43) Pub. Date: May 19, 2011

(54) RECEPTACLE CONNECTOR

(75) Inventor: Sheng-Ming Hsieh, Taipei City (TW)

(73) Assignee: COMPAL ELECTRONICS, INC., Taipei City (TW)

(21) Appl. No.: 12/891,752

(22) Filed: Sep. 27, 2010

Related U.S. Application Data
(60) Provisional application No. 61/262,562, filed on Nov. 19, 2009.

(51) Int. Cl. H01R 24/00

(52) U.S. Cl. 439/660

(57) ABSTRACT

A receptacle connector is adapted to be electrically connected with a plug connector. The plug connector has a plurality of plug terminals. The receptacle connector includes an insulating body and a plurality of receptacle terminals. The insulating body has a receiving space and a plurality of grooves. The plug connector is adapted to be plugged into the receiving space. The receptacle terminals are disposed within the insulating body. Each of the receptacle terminals includes a base disposed in a corresponding groove, a bent portion connected with the base, a contact portion extending from the bent portion into the receiving space, and an engaging portion extending from the contact portion toward the groove and disposed within the groove. The receptacle terminals correspond to the plug terminals such that the plug terminals press the contact portions, respectively, when the plug connector is plugged into the receiving space.

### CROSS-REFERENCE TO RELATED APPLICATION

This application claims the priority benefit of U.S.A. provisional application Ser. No. 61/262,562, filed on Nov. 19, 2009, all disclosures are incorporated therewith.

### BACKGROUND OF THE INVENTION

1. Field of the Invention

The present invention relates to a connector, and more particularly, to a receptacle connector.

2. Description of Related Art

With regard to connectors on current electronic devices for connecting with network apparatus, RJ-45 type receptacle connectors are usually used for connecting with corresponding plug connectors. However, with the electronic devices trending toward being low profile, the standard RJ-45 receptacle connectors have apparently become a bottleneck for further thinner design of electronic devices due to the relatively high profile of the standard RJ-45 receptacle connectors.

FIG. 1 is a sectional view illustrating a conventional receptacle connector prior to being connected with a corresponding plug connector. FIG. 2 is a sectional view illustrating the receptacle connector connected with the corresponding plug connector of FIG. 1. Referring to FIG. 1 and FIG. 2, one end of a receptacle terminal 110 of the conventional RJ-45 receptacle connector 100 is fixed in an insulating body 120, and the other end of the receptacle terminal 110 is bent to form an acute angle and is limited by a stop portion 122 of the insulating body 120. The receptacle terminal 110 is configured to provide a pre-press force. When a plug connector 200 is plugged into the receptacle connector 100, a plug terminal 210 of the plug connector 200 engages with the receptacle terminal 110.

However, in the construction described above, lowering the receptacle connector's height is constrained by the end of the receptacle terminal that is bent and stopped by the stop portion 122. In order to maintain a desired contact force between the receptacle terminal 110 and the plug terminal 210, the height of the receptacle terminal 110 must be maintained constant. In other words, because the height of the receptacle connector 100 cannot be effectively reduced, the receptacle connector 100 has hindered the development of thinner electronic devices.

### SUMMARY OF THE INVENTION

Accordingly, the present invention is directed to a receptacle connector having receptacle terminals with reduced height.

The present invention provides a receptacle connector adapted to be electrically connected with a plug connector. The plug connector has a plurality of plug terminals. The receptacle connector includes an insulating body and a plurality of receptacle terminals. The insulating body has a receiving space and a plurality of grooves. The plug connector is adapted to be plugged into the receiving space. The receptacle terminals are disposed within the insulating body. Each of the receptacle terminals includes a base disposed in a corresponding groove, a bent portion connected with the base, a contact portion extending from the bent portion into the receiving space, and an engaging portion extending from the contact portion toward the groove and disposed within the groove. The receptacle terminals correspond to the plug terminals such that the plug terminals press the contact portions, respectively, when the plug connector is plugged into the receiving space.

In view of the foregoing, in the above embodiment of the present invention, the receptacle terminals disposed within the receptacle connector are bent to reduce the overall height of the receptacle connector. In addition, the contact force between the receptacle terminals and the plug terminals is increased when the plug connector is plugged into the receiving space to make sure that the plug connector will not easily become disengaged from the receptacle connector.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a sectional view illustrating a conventional receptacle connector prior to being connected with a corresponding plug connector.

FIG. 2 is a sectional view illustrating the receptacle connector connected with the corresponding plug connector of FIG. 1.

FIG. 3 is a sectional view illustrating one embodiment of the invention that before a receptacle connector being connected with a corresponding plug connector.

FIG. 4 is a sectional view illustrating that after the receptacle connector being connected with the corresponding plug connector of FIG. 3.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purposes of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

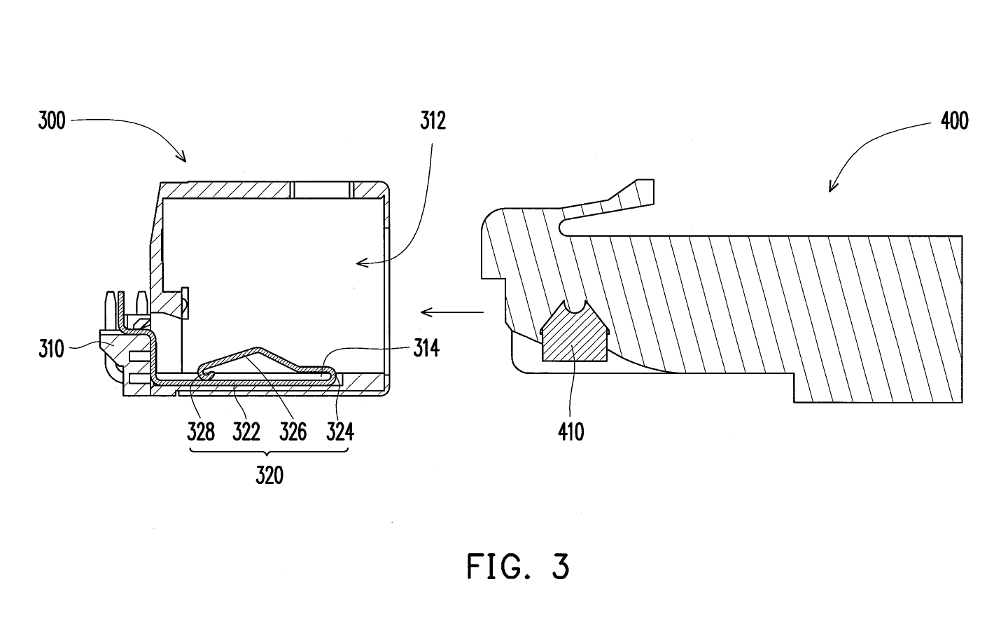

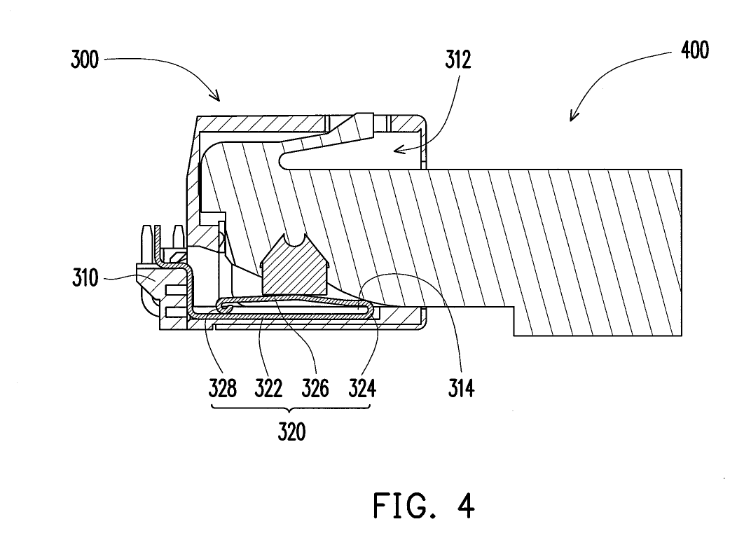

FIG. 3 is a sectional view illustrating one embodiment of the invention that before a receptacle connector being connected with a corresponding plug connector. FIG. 4 is a sectional view illustrating that after the receptacle connector being connected with the corresponding plug connector of FIG. 3. Referring to FIG. 3 and FIG. 4, in the present embodiment, the receptacle connector 300 is adapted to be electrically connected with the corresponding plug connector 400. The receptacle connector 300 includes an insulating body 310 and a plurality of receptacle terminals 320 disposed within the insulating body 310. The insulating body 310 has a receiving space 312 and a plurality of grooves 314. The plug connector 400 is adapted to be plugged into the receiving space 312. The plug connector 400 has a plurality of plug terminals 410 corresponding to the receptacle terminals 320, respectively. Therefore, as the plug connector 400 is plugged into the receiving space 312, the plug terminals 410 press the receptacle terminals 320, respectively, as shown in FIG. 4.

Notably, each receptacle terminal 320 includes a base 322 disposed in a corresponding groove 314, a bent portion 324 connected with the base 322, a contact portion 326 extending from the bent portion 324 into the receiving space 312, and an engaging portion 328 extending from the contact portion 326 toward the corresponding groove 314 and disposed within the corresponding groove 314. The bent portion 324 is substantially U-shaped to provide the receptacle terminals 324 with elasticity. The contact portion 326 is substantially V-shaped to facilitate the contact between the receptacle terminals 320 and the plug terminals 410.

In addition, in the present embodiment, the engaging portion 328 is substantially C-shaped. When the contact portion 326 is pressed by the plug terminal 410, the engaging portion 328 substantially engages against the base 322 and can only slide on the base 322 along the groove 314 due to the structural limitation of the groove 314.

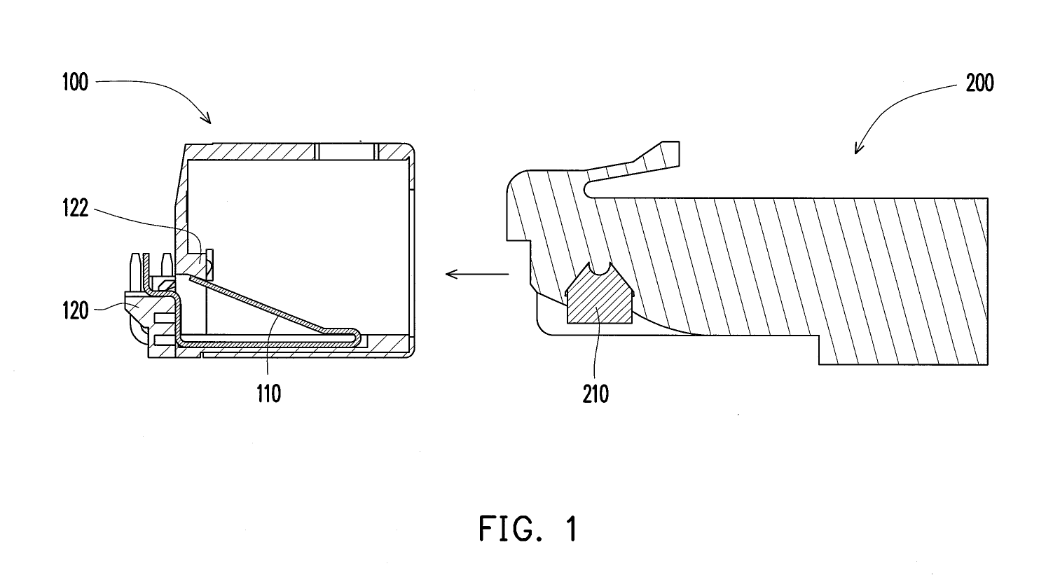

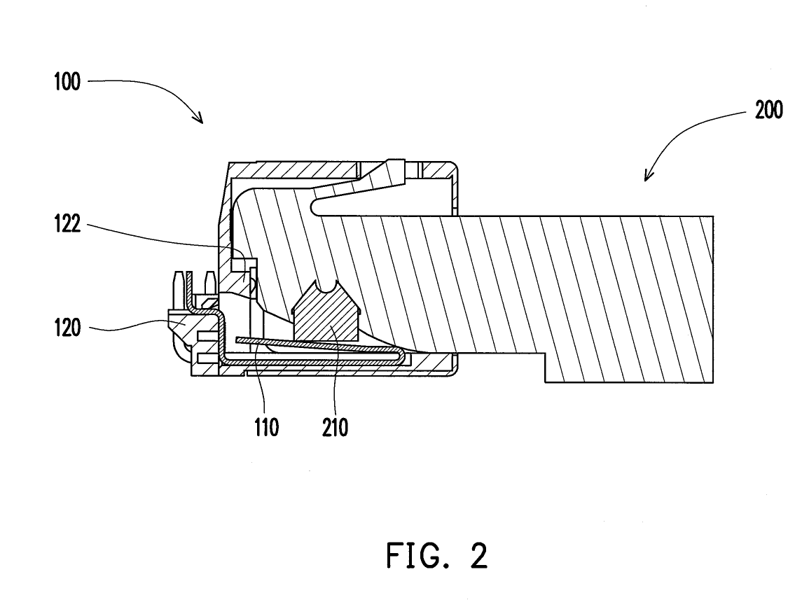

In comparison with the conventional receptacle connector 100 of FIG. 1 and FIG. 2, in the receptacle connector 300 of the present embodiment, the shape of the receptacle terminal 320 is modified such that the receptacle terminal 320 is bent to engage against the receptacle terminal 320 itself. This allows the receptacle terminal 320 to have a lower height than the receptacle terminal 110 of the conventional receptacle connector 100, thus effectively reducing the overall height of the receptacle connector 300.

Besides, because the contact portion 326 and the engaging portion 328 are formed by bending one end of the receptacle terminal 320, the orthogonal projection of the contact portion 326 on the base 322 falls substantially between the orthogonal projection of the engaging portion 328 on the base 322 and the orthogonal projection of the bent portion 324 on the base 322. When the plug connector 400 is plugged into the receiving space 312, making the plug terminals 410 pressing the contact portions 326 of the receptacle terminals 320, the engaging portions 328 engage against the bases 322. As such, both the engaging portions 328 and bent portions 324 of the receptacle terminals 320 can provide a contact force against the plug terminals 410 to increase the insertion force between the plug connector 400 and the receptacle connector 300, thereby preventing the plug connector 400 from easily becoming disengaged from the receptacle connector 300. The contact portions 326 act as a fulcrum and provide a sufficient contact force in cooperation with the respective engaging portions 328, thus effectively reducing the height of the receptacle terminals 320.

In summary, in the foregoing embodiment of the present invention, the receptacle terminals disposed within the receptacle connector are bent to have a lower height with respective to the terminal bases when compared with the conventional receptacle connector, thus reducing the overall height of the receptacle connector.

In addition, bending of the receptacle terminals also changes the pressing position between the conventional receptacle connector and the plug connector, thus increasing the contact force between the receptacle terminals and the plug terminals. This allows the plug connector to be stably received within the receptacle connector.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A receptacle connector adapted to be electrically connected with a plug connector, the plug connector having a plurality of plug terminals, the receptacle connector comprising:
an insulating body having a receiving space and a plurality of grooves, the plug connector being adapted to be plugged into the receiving space; and
a plurality of receptacle terminals disposed within the insulating body, each of the receptacle terminals comprising a base disposed in a corresponding groove, a bent portion connected with the base, a contact portion extending from the bent portion into the receiving space, and an engaging portion extending from the contact portion toward the groove and disposed within the groove, the receptacle terminals corresponding to the plug terminals such that the plug terminals press the contact portions, respectively, when the plug connector is plugged into the receiving space.

2. The receptacle connector according to claim 1, wherein the base is disposed within the groove, and a corresponding engaging portion engages against the base.

3. The receptacle connector according to claim 1, wherein the orthogonal projection of the contact portion on the base falls substantially between the orthogonal projection of the engaging portion on the base and the orthogonal projection of the bent portion on the base.

4. The receptacle connector according to claim 1, wherein the bent portion is substantially U-shaped.

5. The receptacle connector according to claim 1, wherein the contact portion is substantially V-shaped.

6. The receptacle connector according to claim 1, wherein the engaging portion is substantially C-shaped.

7. The receptacle connector according to claim 1, wherein the connector is a RJ-45 network connector.
